(19) United States
(12) Patent Application Publication
(10) Pub. No.: US 2004/0118431 A1
(43) Pub. Date: Jun. 24, 2004

(54) Water towelettes

(76) Inventor: Robert R. Flynn, North Royalton, OH (US)

Correspondence Address: Timothy D. Bennett, Brouse McDowell, 500 First National Tower, Akron, OH, 44308-1471, US

(21) Appl. No.: 10/325,126

(22) Filed: Dec. 19, 2002

(51) Int. Cl. A47L 13/17; B08B 1/00; B08B 7/00

(52) U.S. Cl. 134/6; 15/104.93; 206/210; 206/233; 206/812

(57) ABSTRACT

A sealed packaging member includes a disposable wiping member for cleaning debris from a surface, such as, an eating utensil, a beverage container or a person's skin. The wiping member is sealed from exposure to the environment until unsealed by an associated operator. The wiping member may be saturated with purified water and contains no cleaning solution.

### 1. BACKGROUND OF THE INVENTION

A. Field of Invention

This invention pertains to the art of methods and apparatuses for non-detergent cleaning of items and more specifically to methods and apparatuses for removing debris from items such as a food product utensil.

B. Description of the Related Art

It is known in the art for various items to be provided by businesses and/or individuals to be used by the public. Often these items should be properly cleaned before they are used by the members of the public. Various methods for cleaning such items are known. Perhaps the most well known method is the use of dry products such as napkins, paper towels and the like. The problem with such dry products is that often moisture is required to properly clean the item to be cleaned.

Non-dry or moist cleaning products are also well known. However, all known moist cleaning products use some type of detergent (such as alcohol) for such cleaning. For example, hand sanitizers having an alcohol base are well known. Such detergent cleaning products work well for their intended purpose. However, there are times when a non-detergent yet moist cleaning device would be desirable. For example, it is well known for a restaurant to set out non-disposable eating utensils for use by patrons of the eating establishment. A well known problem is that such eating utensils may inadvertently be set out for use even though such eating utensils contain unwanted debris. Such unwanted debris may be found even when the utensil has been washed by commercial or other washing devices. Sometimes the unwanted debris is simply the “water spots” left on the utensil after the utensil has been washed. What is needed is an easy and convenient way for users to be able to clean such utensils without the use of detergents.

Other items, besides eating utensils, also may require cleaning before use by the consumer. These other items include, condiment containers, salt/pepper shakers, beverage containers and the like. What is needed is a way to conveniently cleanse such items from debris or other substances with a sanitary yet non-detergent cleansing device.

A person may also desire a moist cleaning member to use on that person's body. For example, a person may wipe sweat from their forehead or use the cleaning member for use in cleaning a person's teeth. Again, a sanitary yet non-detergent cleansing device may be desired.

### II. SUMMARY OF THE INVENTION

According to one aspect of the present invention, a cleaning member is sealed in a selectively open-able container.

In another aspect of the present invention, the selectively open-able containers may be positioned in multiple quantities in a restaurant setting for use by an associated user.

Yet another aspect of the subject invention includes a textured cleaning member sealed from exposure to the environment in a flexible package.

Still yet another aspect of the subject invention includes a cleaning member saturated with water for use in cleaning an associated article.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of the packaging members containing a cleaning member.

FIG. 2 is a perspective view of the unsealed packaging member exposing the cleaning member to the environment.

FIG. 3 is a perspective view of the cleaning member being used to clean an eating utensil.

FIG. 4 is a perspective view of the cleaning member being used to clean a beverage container.

### IV. DESCRIPTION OF THE PREFERRED EMBODIMENT

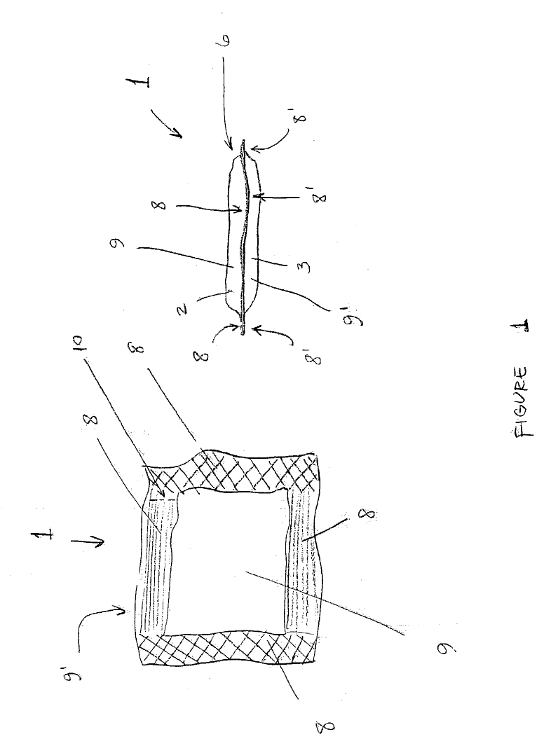

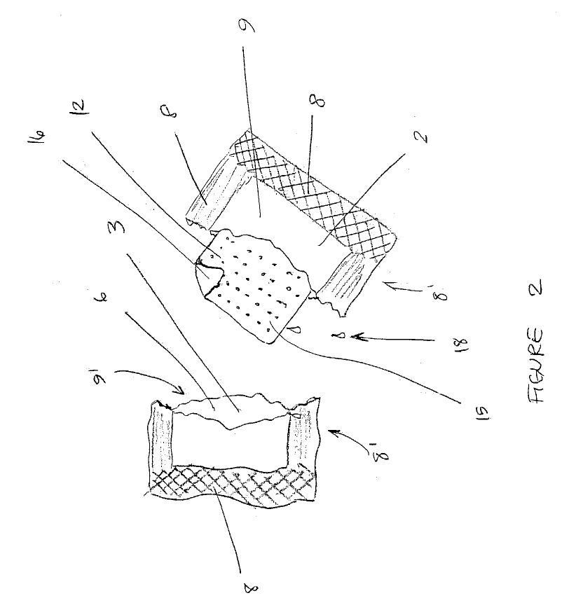

Referring now to the drawings wherein the showings are for purposes of illustrating a preferred embodiment of the invention only and not for purposes of limiting the same, FIG. 1 shows two views of a substantially planar package depicted generally at 1. The package 1 may include first and second package members 2, 3, which may be juxtaposed to form an inner region 6, depicted most clearly in FIG. 2. The package members 2, 3 may include edges 8, 8′ respectively having first and second sides. The first sides of the edges 8, 8′ of the package members 2, 3 may be fastened together to seal the inner region 6 or inner cavity 6 from the atmosphere. The edges 8, 8′ may be adhesively sealed such that no air may leak into or out of the inner region 6. It should be noted that any manner of sealing the first sides of the edges 8, 8′ may be chosen with sound engineering judgment. The package member 2, 3 may also include center portions 9, 9′ which are not sealed together but may be juxtaposed to form the inner region having a characteristic volume V.

With continued reference to FIG. 1, the package member 2, 3 may be flexible package members 2, 3 that conform to twisting or handling. In one embodiment, the flexible package members 2, 3 may be constructed so that an associated user may tear the edges 8, 8′ of the sealed package members 2, 3 to expose the inner region 6 of the package 1. It is also contemplated in an alternate embodiment, that the package member 2, 3 may be perforated, shown at 10, to allow for easier tearing of the package members 2, 3. In this manner, the package 1 may be selectively torn or unsealed for exposing the inner cavity 6 to the environment. The outer surface of the package 1 is readily available for use as an information and/or advertising area. Thus, company logos, information of the contents, etc. can be easily provided.

With reference now to FIG. 2, a selectively torn package 1 is shown. The package 1 may include a cleaning member 12. The cleaning member 12 may have first and second sides 15, 16. The cleaning member 12 may be constructed from a cloth material, paper material or the like and may be referred to as a towelette. Consequently, the cleaning member 12 may be fashioned from any material chosen with sound judgment that is appropriate for use the invention described herein. The cleaning member 12 may be contained within the inner cavity 6. In this way, when the package 1 is sealed from exposure to the atmosphere, the cleaning member 12 is sealed from exposure to the atmosphere or environment.

With continued reference to FIG. 2, as noted the cleaning member 12 may include first and second sides 15, 16. The first side 15 of the cleaning member 15 may be textured with respect to the second side 16 of the cleaning member 12. In this manner, the first side 15 may include raised ridges or bumps and the second side may be devoid of such texturing; smooth, formed without such texturing. However, any manner of texturing the first and second sides 15, 16 respectively may be chosen with sound engineering judgment. Alternately, it is contemplated that the first and second 15, 16 sides of the cleaning member 12 may have the same texture, whether smooth or textured. This variation in texturing provides for alternate cleaning surfaces as required by the item to be cleaned.

With continued reference to FIG. 2, the cleaning member 12 may be saturated (or pre-moistened) with water, depicted generally at 18. It is preferred that the water used to saturate the cleaning member 12 is purified. By purified it is meant that the water could be safely consumed by humans and animals. For example, the purified water may be similar in quality to the water commercially sold for drinking purposes. In addition, the water 18 may be de-ionized water 18. As an option, the water may be formulated with an anti-bacterial solution that kills germs on non-porous surfaces. If such a solution is used, the cleaning member 12 would preferably not leave any particles from the solution on the item being cleaned. Preferably the water within which the cleaning member 12 is packaged is colorless, odorless, non-toxic, non-staining and environmentally friendly. The cleaning member 12 is sealed from exposure to the environment and thus is sterile. The water 18 contained therein is also sealed from evaporating into the atmosphere. This functions to assist the associated user in wiping and thus cleaning an associated article to be cleaned.

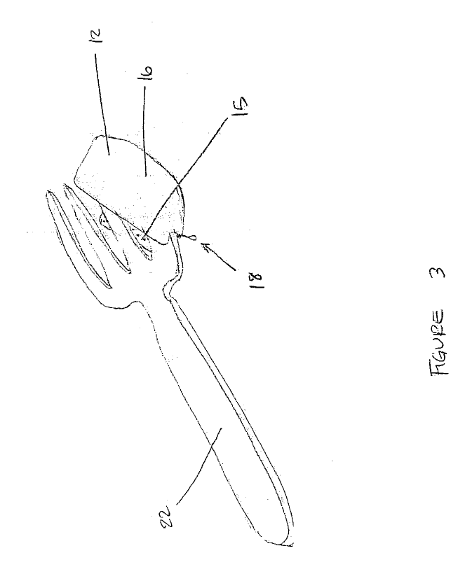

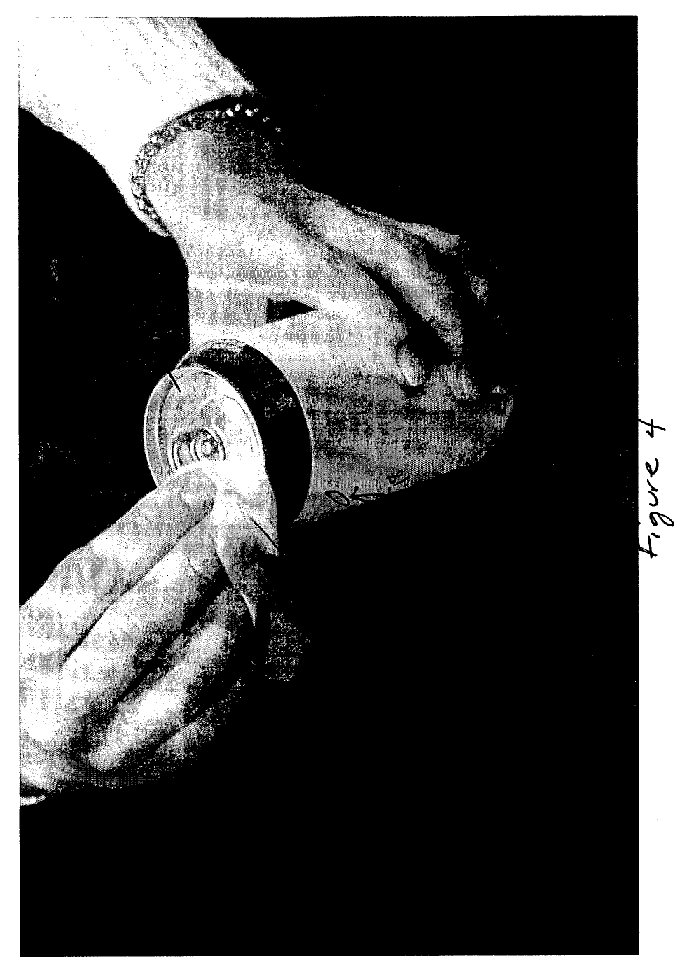

With continued reference to FIGS. 1 and 2 and now to FIGS. 3 and 4, operation of the subject invention will now be discussed. An associated user may grasp the package 1 in one hand and with the other hand engage in a tearing motion to open the sealed the package 1. It is noted that the user may tear the package 1 at the perforation 10 as noted above. The associated user may then grasp the cleaning member 12 on the appropriate side to wipe off a surface requiring cleansing. Items to be cleansed may include associated eating utensils 22, shown in FIG. 3, salt and pepper shakers, drinking cups/glasses or the like. Items to be cleansed may also include beverage containers 30 as shown in FIG. 4. Although FIG. 4 shows a can, it is to be understood that a beverage container 30 could be of any type including cans, bottles, boxes and other items made of any known material including aluminum, plastic, glass and paper products. The cleaning member 12 may be used to wipe and thus clean any item chosen with sound judgment as is appropriate for use with the subject invention. It should be noted that applicant also contemplates use of the inventive cleaning member on a person's or animal's body. For example, the cleaning member 12 could be used to wipe perspiration from the forehead of a person. The cleaning member 12 could also be used to wipe or clean a person's or animal's teeth to remove unwanted food debris. After use, the cleaning member 12 can simply be disposed of.

It is contemplated that a plurality of cleaning members 12, within their respective packages 1, can be provided for ready access by members of the public. Thus, for example, a container of cleaning members 12 may be provided at restaurant tables.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A device for removing debris from an associated surface, comprising:
a packaging member forming an inner cavity, the inner cavity of the packaging member being selectively sealed from exposure to the environment, wherein the packaging member is operable to be unsealed by an associated operator's hands;
a disposable cleaning member having first and second sides, the cleaning member residing completely within the inner cavity; and,
wherein the cleaning member is saturated only with water.

2. The device of claim 1, wherein the water is purified water.

3. The device of claim 2, wherein the purified water is de-ionized.

4. The device of claim 1, wherein the texture of the first side of the cleaning member is substantially different from the texture of the second side of the cleaning member.

5. The device of claim 4, wherein the texture of the first side of the cleaning member is relatively course, and,
wherein the texture of the second side of the cleaning member is relatively smooth.

6. The device of claim 2, wherein the cleaning member is adapted to remove debris from an eating utensil.

7. The device of claim 2, wherein the cleaning member is adapted to remove debris from a beverage container.

8. The device of claim 2, wherein the cleaning member is adapted to contact human skin.

9. The device of claim 2, wherein the cleaning member is adapted to remove debris from a person's teeth.

10. A method for removing debris from an associated surface, the steps comprising:
providing a packaging member forming an inner cavity, the inner cavity of the packaging member being selectively sealed from exposure to the environment, wherein the packaging member is operable to be unsealed by an associated operator's hands; and,
providing a cleaning member having first and second sides, the cleaning member residing completely within the inner cavity, wherein the cleaning member is at least partially saturated only with water;
grasping the packaging member;
tearing the packaging member exposing the cleaning member to the environment;
removing the cleaning member from the inner cavity; and,
rubbing the cleaning member on the associated surface.

11. The method of claim 10, further comprising the step of:
disposing of the cleaning member.
